(19) United States
(12) Patent Application Publication
(10) Pub. No.: US 2011/0038729 A1
(43) Pub. Date: Feb. 17, 2011

(54) WIND TURBINES

(75) Inventors: Dennis Shymanski, Windsor (CA); Greg Presland, Cottom (CA); Rajesh Kadikar, Windsor (CA); Lynn Johner, Edmonton (CA); Robert Small, Windsor (CA)

Correspondence Address: GIFFORD, KRASS, SPRINKLE,ANDERSON & CITKOWSKI, P.C, PO BOX 7021, TROY, MI, 48007-7021, US

(73) Assignee: EcoTemp International, Inc., Windsor (CA)

(21) Appl. No.: 12/853,377

(22) Filed: Aug. 10, 2010

Related U.S. Application Data
(60) Provisional application No. 61/233,066, filed on Aug. 11, 2009.

(51) Int. Cl. F03D 11/00

(52) U.S. Cl. 416/39; 416/95

(57) ABSTRACT

A wind turbine having at least one air foil with a leading edge and a trailing edge and in which the air foil is rotatably mounted about an axis. A thermoelectric film is disposed over at least a portion of the leading edge of the air foil and this thermoelectric film generates heat upon application of a voltage differential across the thermoelectric film. A control unit is electrically connected to and controls the application of the voltage differential across the thermoelectric film to deice the air foil.

### CROSS REFERENCE TO RELATED APPLICATIONS

This application claims priority of U.S. Provisional Patent Application Ser. No. 61/233,066 filed Aug. 11, 2009, which is incorporated herein by reference.

### BACKGROUND OF THE INVENTION

I. Field of the Invention

The present invention relates generally to wind turbines and, more particularly, to a wind turbine with deicing capability.

II. Description of Related Art

The use of wind turbines to generate electric power has enjoyed a rapid increase in recent years. This increase is due in large part to the wind turbines' ability to harness wind power which has previously been only marginally exploited.

The prior wind turbines include a base having at least one, and more typically two or more air foils rotatably mounted about an axis adjacent the top of the base and in which the air foils rotatably drive a generator. Each air foil, furthermore, includes a leading edge and a trailing edge and the cross-sectional shape of the air foil is typically designed for maximum aerodynamic efficiency.

One difficulty of utilizing wind turbines, especially in cold climates, is that ice buildup on the air foil can occur. Such ice buildup not only affects the overall efficiency of the wind turbine, but also increases the mechanical load on the air foils and also on the remaining components of the wind turbine. Such an increased mechanical load not only increases the wear and tear on the wind turbine components, but in severe cases can even result in damage to the overall wind turbine.

### SUMMARY OF THE PRESENT INVENTION

The present invention provides a wind turbine construction which overcomes the above-mentioned disadvantages of the previously known wind turbines.

In brief, the wind turbine of the present invention includes at least one air foil rotatably mounted about an axis. In the conventional fashion, the rotatably mounted air foil is supported at or adjacent the top of a base and, upon rotation, rotatably drives a generator.

A thermoelectric film is disposed over at least a portion of the leading edge of the air foil. This thermoelectric film generates heat upon application of a voltage differential across the thermoelectric film. Consequently, in the event of an ice or frost buildup on the air foil, energization of the thermoelectric film effectively melts the ice or frost in the desired fashion.

A control unit is provided which is electrically connected to the thermoelectric film. The control unit optionally includes a temperature sensor which provides an input signal to the control unit. The control unit is programmed to control the energization of the thermoelectric film to deice the air foil as required.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating a wind turbine in accordance with the present invention;

FIG. 2 is a plan view illustrating a thermoelectric film;

FIG. 3 is a plan view illustrating one air foil of the wind turbine of the present invention; and

FIG. 4 is a sectional view taken substantially along line 4-4 in FIG. 3 and enlarged for clarity.

### DETAILED DESCRIPTION OF A PREFERRED EMBODIMENT OF THE PRESENT INVENTION

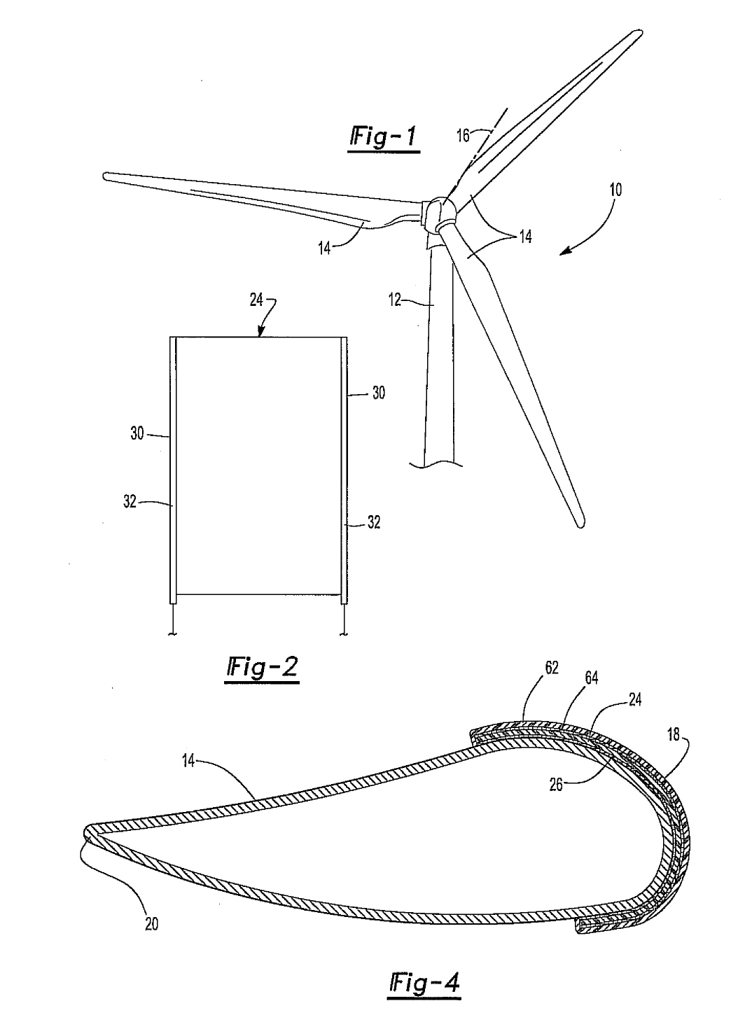

With reference first to FIG. 1, a wind turbine 10 in accordance with the present invention is illustrated. The wind turbine includes a base 12 which rotatably supports one or more air foils 14 adjacent its upper end. These air foils 14 are rotatable about an axis 16 relative to the base 12 and, upon rotation, rotatably drive a generator (not shown).

With reference now particularly to FIG. 4, the air foil 14 includes a leading edge 18 and a trailing edge 20. The overall cross-sectional shape of the air foil 14 is preferably aerodynamically designed for maximum efficiency of the wind turbine 10.

With reference now to FIGS. 2-4, a thermoelectric film 24 is disposed over the leading edge 18 of the air foil 14 so that the film 24 covers at least a part of, and preferably substantially all of, the air foil leading edge 18. The thermoelectric film 24 is attached to the air foil 14 in any conventional fashion, such as by an adhesive layer 26.

The thermoelectric film 24 is best shown in FIG. 2 and is made of a polymer, such as polyimide, impregnated with carbon or other electrically semiconductive material. The film 24 includes spaced apart sides 30 and a bus bar 32 constructed of a conductive material, such as silver, disposed along opposed sides of the film 24.

Upon application of a voltage differential to the bus bars 32, current flows through the thermoelectric film 24. Such current flow, in turn, causes heating of the film 24. Consequently, upon energization of the thermoelectric film 24 by the application of a voltage differential between the bus bars 32, the thermoelectric film 24 heats the leading edge 18 of the air foil 14 thereby deicing the air foil 14 or preventing an ice buildup.

The size of the thermoelectric film 24, as well as the voltage differential applied to the bus bars 32, will vary from one wind turbine to the other not only as a function of the wind turbine size, but also the operating environment for the wind turbine. For example, additional heating capability of the thermoelectric film 94 may be necessary for extremely cold operating conditions, such as in the Arctic Circle, versus a more temperate operating environment.

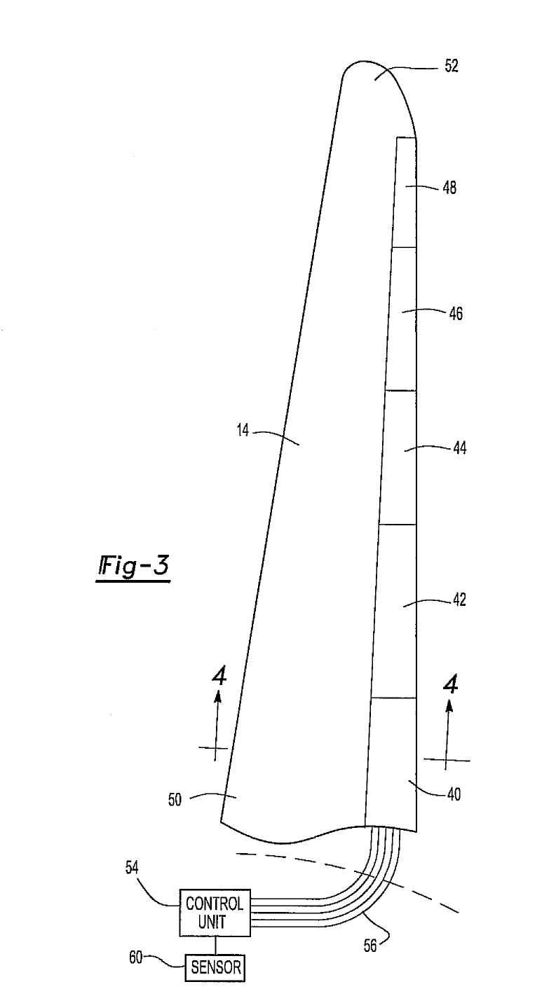

With reference now to FIG. 3, the thermoelectric film 24 preferably is comprised of a plurality of film segments 40, 42, 44, 46 and 48 which extend from a root 50 of the air foil 14 to a tip 52 of the air foil 14. Each film segment 40-48 may be energized independently of the other film segments.

Although five film segments 40-48 are illustrated in FIG. 3 as extending radially adjacent each other along the leading edge 18 of the air foil 14, it will be understood that fewer or more film segments 40-48 may be utilized without deviation from the spirit or scope of the instant invention. However, in the preferred embodiment of the invention, the number of thermoelectric film segments 40-48 is the same for each of the air foils 14 on the wind turbine 10.

Still referring to FIG. 3, a control unit 54 is electrically connected to each of the thermoelectric film segments 40-48 via electrical wires 56. This control unit 54 thus controls the activation or energization of each thermoelectric film segment 40-48. The control unit optionally receives, as an input signal, the output from a temperature sensor 60 to determine when, and for how long, the energization of the thermoelectric film segments 40-48 is required to properly deice the air foil 14.

In order to maintain proper balance and increase efficiency, the control unit 54 energizes the same thermoelectric film segment 40-48 simultaneously on all of the wind turbine air foils 14. For example, the control unit 54, which may be microprocessor controlled, is programmed to simultaneously energize the thermoelectric film segment 40 for a predetermined time period on each air foil 14 followed by the energization of the thermoelectric film segment 42 for a second time period on each air foil 14 and so on for all of the thermoelectric film segments 40-48. In this fashion, each of the air foils 14 is deiced in substantially the same fashion.

With reference now to FIG. 4, in order to protect the thermoelectric film 24 from damage from environmental damage, a protective cover 62 overlies the thermoelectric film 24 and is attached to the thermoelectric film 24 in any conventional fashion, such as by an adhesive layer 64. This protective cover 62 is preferably both water resistant as well as ultraviolet ray absorbent to protect the thermoelectric film 18 from both water and sun damage. The protective cover is preferably a thin cover, e.g. 2 millimeters, of a polymer and may be painted over the film 24.

In operation, the control unit, optionally in response to the temperature reading from the sensor 60, sequentially energizes the film segments 40-48 on all of the air foils 14 by a time sufficient to deice the air foils 14. Preferably, the energization of the thermoelectric film segments 40-48 is both sequential and in a fashion such that only one film segment 40-48 is energized at any given time. However, two or even more film segments 40-48 on each air foil 14 may be simultaneously energized without deviating from the spirit or scope of the invention.

From the foregoing, it can be seen that the present invention provides an effective means for deicing the air foils on a wind turbine. Having described our invention, however, many modifications thereto will become apparent to those skilled in the art to which it pertains without deviation from the spirit of the invention as defined by the scope of the appended claims.

We claim:

1. A wind turbine comprising:
at least one air foil having a leading edge and a trailing edge, said air foil being rotatably mounted around an axis,
a thermoelectric film disposed over at least a portion of said leading edge of said air foil, said thermoelectric film generating heat upon application of a voltage differential across said thermoelectric film,
a control unit which is electrically connected to and controls the application of said voltage differential across said thermoelectric film.

2. The wind turbine as defined in claim 1 wherein said thermoelectric film comprises a plurality of said thermoelectric film segments, said film segments being positioned linearly adjacent each other on said air foil in a radial direction with respect to said axis.

3. The wind turbine as defined in claim 1 wherein said thermoelectric film comprises a carbon impregnated polyimide film.

4. The wind turbine as defined in claim 1 wherein said thermoelectric film is adhesively attached to said air foil.

5. The wind turbine as defined in claim 1 and comprising a protective cover overlying said thermoelectric film.

6. The wind turbine as defined in claim 5 wherein said protective cover is made of a water resistant material.

7. The wind turbine as defined in claim 6 wherein said protective cover is made of an ultraviolet ray resistant material.

8. The wind turbine as defined in claim 6 wherein said protective cover is adhesively attached to said thermoelectric film.

9. The wind turbine as defined in claim 2 wherein said control unit sequentially applies said voltage differential to said thermoelectric film segments in sequential time segments.

10. The wind turbine as defined in claim 1 wherein said thermoelectric film covers substantially the entire leading edge of said air foil.

11. The wind turbine as defined in claim 1 and comprising a temperature sensor electrically connected as an input signal to said control unit.
